(19) United States
(12) Patent Application Publication
(10) Pub. No.: US 2024/0379096 A1
(43) Pub. Date: Nov. 14, 2024

(54) RETRIEVAL-AUGMENTED PROMPT FOR INTENT DETECTION

(71) Applicant: MICROSOFT TECHNOLOGY LICENSING, LLC., REDMOND, WA (US)

(72) Inventors: ANEESH BOSE, KOLKATA (IN); KRZYSZTOF STANISLAW CIESLAK, LODZ (PL); PRIYANKAR KUMAR, NEW DELHI (IN); RAHUL PANDITA, ARVADA, CO (US); ARJUNA GANESH SITTAMPALAM, ST. NEOTS (GB); TAMAS SZABO, STUTTGART (DE)

(21) Appl. No.: 18/196,027

(22) Filed: May 11, 2023

(51) Int. Cl. G10L 15/18; G10L 15/10

(52) U.S. Cl. CPC G10L 15/1815; G10L 15/10

(57) ABSTRACT

A large language model is used to detect the intent of a developer-spoken utterance. The large language model is pre-trained on natural language text and source code. A prompt to the large language model is augmented with a few-shot examples of pairs of an utterance and intent in order to guide the model to predict an intent for a given utterance. The few-shot examples are extracted from known utterance-intent pairs. The pairs closest to the developer-spoken utterance are incorporated into the prompt as the few-shot examples.

### BACKGROUND

A voice user interface for a software application allows a developer (i.e., user, programmer, etc.) to interact with the software application through speech without needing a keyboard or touch screen. The voice user interface is useful when it is not convenient for a developer to use the keyboard or touch screen.

An integrated development environment (IDE) is a software framework used to aid software developers to develop, test, debug, and package a software application. The integrated development environment includes various tools, such as source code editors for various programming languages, debuggers, visual designers, compilers, testing tools, package creation tools, and the like.

A voice user interface for an IDE is challenging due to the vast number of tasks that the IDE can perform. There are numerous commands for editing a source code program with each consisting of a particular format with zero or more parameters that need to be input to perform a particular task. There are also numerous commands for compiling source code and for debugging the execution of the source code program. In order to perform any of these tasks, the voice user interface needs to detect the intent of the developer from the developer's spoken speech. However, mistakes in the detection of an intent may frustrate the developer from using the IDE.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A large language model is used to detect the intent of a developer-spoken utterance. The large language model is pre-trained on natural language text and source code. A prompt to the large language model is augmented with few-shot examples of pairs of an utterance and intent in order to guide the model on the intent detection task. The few-shot examples are extracted from known utterance-intent pairs. The pairs closest to the developer-spoken utterance are incorporated into the prompt.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system of an intent detection system utilizing retrieval-augmented prompts.

FIG. 2 is a schematic diagram illustrating an exemplary system for generating the utterance-intent database storing the few-shot examples.

FIG. 3 is a schematic diagram illustrating an exemplary prompt.

FIG. 4 is a schematic diagram illustrating a large language model as a neural transformer model with attention in an encoder-decoder configuration.

FIG. 5 is a flow diagram illustrating an exemplary method of the intent detection system.

FIG. 6 is a flow diagram illustrating an exemplary method for intent detection using a large language model.

FIG. 7 is a block diagram illustrating an exemplary operating environment.

### DETAILED DESCRIPTION

### Overview

Aspects of the present disclosure pertain to augmenting a prompt with a few-shot examples for a large language model to predict an intent given an utterance. An utterance is developer-spoken speech used to activate a particular task in a software development environment, such as without limitation, an IDE. The utterance may include a fragment, a sentence, multiple sentences, one or more words, one or more questions, and any combination thereof. The intent is an action that needs to be performed by the IDE which is the purpose of the developer-spoken speech. The large language model is used to translate the developer-spoken speech into an action of the IDE.

The few-shot examples are pairs of an utterance with its corresponding intent derived from known data. A database stores the utterance and intent pairs where each pair is indexed by an embedding of the utterance. The embedding of the utterance is used to index an entry of the database for a corresponding intent. A search of the database is made to obtain the top-k intents that are closest to a developer-spoken utterance using the embedding of the developer-spoken utterance and the embeddings of the utterances stored in the database.

The large language model is pre-trained on natural language text and source code programs. However, the model is not trained on the task of translating an utterance into an intent. Fine-tuning the model on this task would require a large number of data samples and a large number of computing resources and computation time which may not be readily available. Few-shot prompting is a low-cost solution that can be employed to dynamically guide the model at inference to generalize on unseen data using a few labeled examples referred to as the few-shot examples.

Attention now turns to a more detailed description of the system, method, and components for the extended augmentation of prompts for code completion.

### System

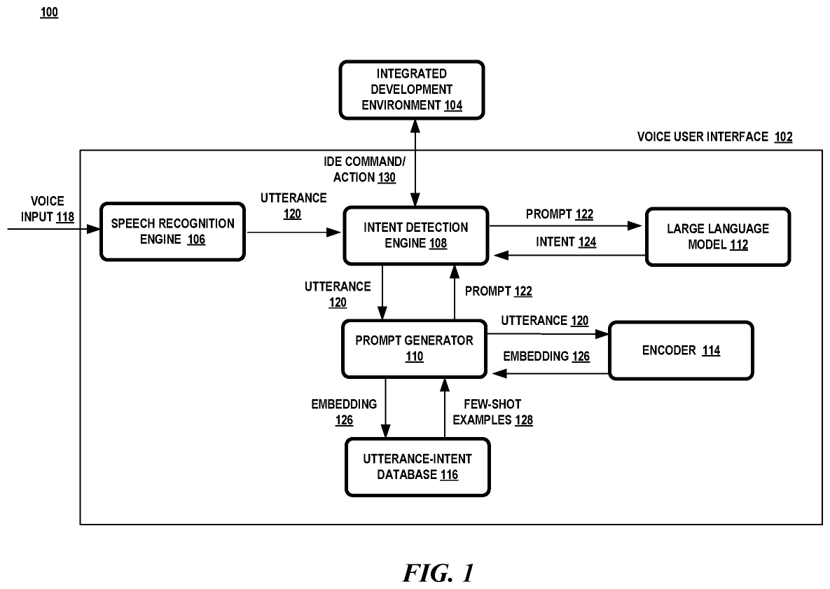

FIG. 1 illustrates a block diagram of an exemplary system 100 having a voice user interface 102 communicatively coupled to an integrated development environment 104. The voice user interface 102 comprises a speech recognition engine 106, an intent detection engine 108, a prompt generator 110, a large language model 112, an encoder 114 and an utterance-intent database 116.

The speech recognition engine 106 receives a voice or audio input 118 from a developer which is transformed into natural language text. The speech recognition engine 106 receives the voice input 118 from a microphone or other input mechanism of a computing device and processes the speech signals to recognize the uttered text or utterance.

The intent detection engine 108 receives the utterance 120 and uses a large language model 112 to identify the intent. The intent is one or more actions that the developer wants to execute in the IDE 104. The intent may include source code, natural language text, and/or a combination thereof. The large language model 112 is given a prompt 122 that is generated by the prompt generator 110. The prompt 122 includes a set of instructions, a few-shot examples, and the utterance.

In an aspect, the large language model 122 is a sequence-to-sequence neural transformer model with attention in an encoder-decoder configuration. Examples of an encoder-decoder neural transformer model with attention include any one of the publicly-accessible large language models offered by OpenAI, Google, Facebook, and Microsoft.

The few-shot examples 128 are extracted from an utterance-intent database 116. The utterance-intent database 116 is indexed by an embedding. The embedding is generated by an encoder 114 which can be a Bag-of-Words model, a neural transformer model with attention, or the like. The prompt generator 110 obtains an embedding for the utterance which is then used to search the utterance-intent database for the top-k few-shot examples matching an embedding of the utterance, where k is a user-defined value.

In an aspect, the voice user interface 102 is a user interface for an integrated development environment. The voice user interface 102 may be an add-on, plug-in, or feature of the integrated development environment. The voice user interface 102 generates one or more text-based actions that are transmitted to the integrated development environment 102 to perform the developer's desired task.

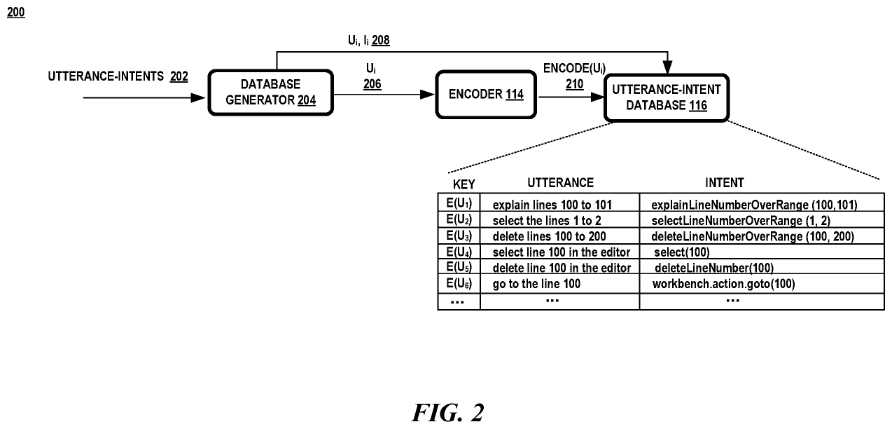

FIG. 2 illustrates a system 200 used to generate the utterance-intent database and to search for intents. Referring to FIGS. 1 and 2, the database generator 204 receives known utterance and intent pairs 202. The database generator 204 uses the encoder 114 to generate an embedding of each utterance, Encode (Uᵢ) 210, which is used as an index to the utterance-intent database 116 for an utterance-intent pair 208.

As shown in the exemplary utterance-intent database 116, an utterance may include “explain lines 100 to 101” and its corresponding intSPEC 17ent is “explainLineNumberOverRange (100, 101).” The intent, in this example, is a method invocation of the application programming interface, explainLineNumberOverRange, with the parameters (100, 101) which is sent to the IDE where it is executed.

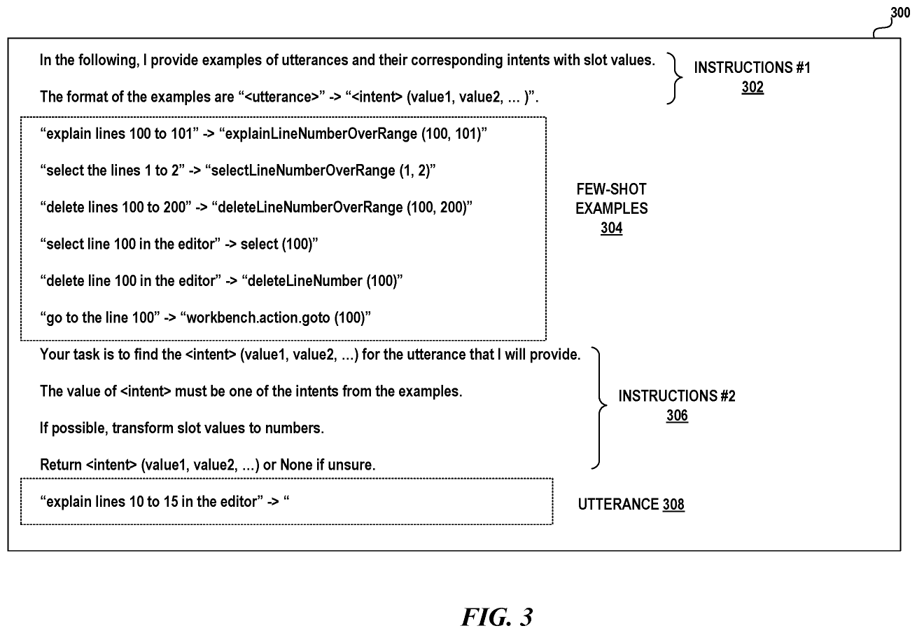

FIG. 3 illustrates an exemplary prompt 300. The prompt 300 includes a first set of instructions 302, the few-shot examples 304, a second set of instructions 304, and the utterance 308.

The first set of instruction 302 describes the few-shot examples—“In the following, I provide examples of utterances and their corresponding intents with slot values. The format of the examples is “<utterance>”-> “<intent> (value1, value2, . . . ).”

The few-shot examples 304 follow the first set of instructions and in FIG. 3, there are six few-shot examples which include the following:
“explain lines 100 to 101”-> “explainLineNumberOverRange (100, 101)”
“select the lines 1 to 2”-> “selectLineNumberOverRange (1, 2)”
“delete lines 100 to 200-> “deleteLineNumberOverRange (100, 200)”
“select line 100 in the editor”-> “select (100)”
“delete line 100 in the editor” > “deleteLineNumber (100)”
“go to the line 100”-> “workbench.action.goto (100)”

The second set of instructions 306 defines the task for the model. The last line is the utterance, 308, “explain lines 10 to 15 in the editor->”.

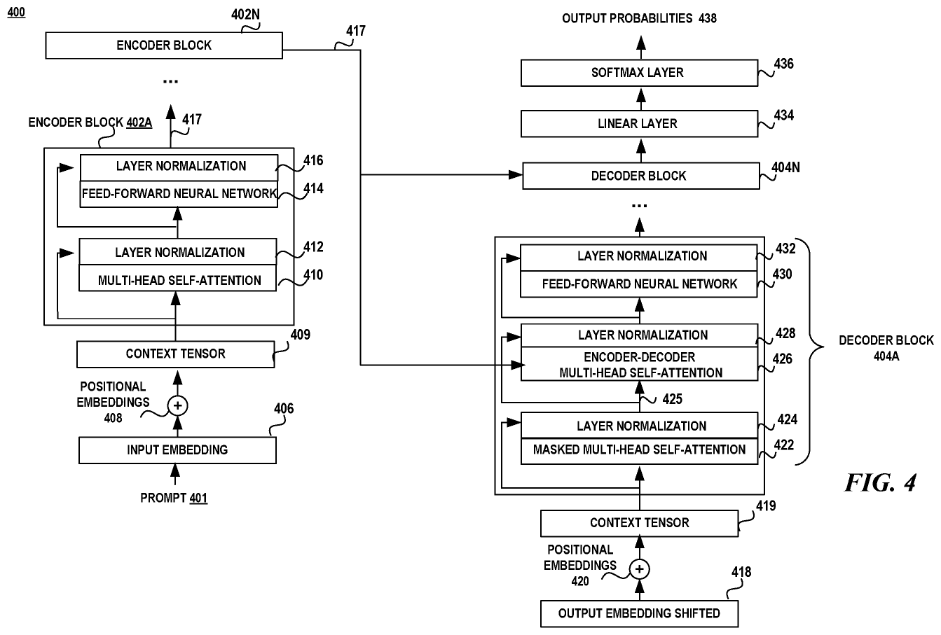

FIG. 4 illustrates an exemplary configuration of the large language model as an encoder-decoder neural transformer with attention. A large language model is a deep machine-learning model that contains billions of parameters. Parameters are the parts of the model learned from the training datasets that define the skill of the model to generate predictions for a target task.

A deep machine learning model differs from traditional machine-learning models that do not use neural networks. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes statistical techniques, data mining, Bayesian networks, Markov models, clustering, support vector machine, and visual data mapping.

Deep machine learning differs from traditional machine learning since it uses multiple stages of data processing through many hidden layers of a neural network to learn and interpret the features and the relationships between the features. Deep machine learning embodies neural networks which differs from the traditional machine learning techniques that do not use neural networks. There are various types of deep machine learning models that generate source code, such as recurrent neural network (RNN) models, convolutional neural network (CNN) models, long short-term memory (LSTM) models, and neural transformers with attention.

FIG. 4 shows an exemplary structure of the neural transformer model with attention in an encoder-decoder configuration. The neural transformer model with attention 400 contains one or more encoder blocks 402 and one or more decoder blocks 404. The initial inputs to an encoder block 402 are the input embeddings 406 of the prompt 401. In order to retain the order of the tokens in the prompt or input sequence, positional embeddings 408 are added to the input embedding 406 forming a context tensor 409. The initial inputs to the first decoder block 404A are a shifted sequence of the output embeddings 418 to which the positional embeddings 420 are added forming context tensor 419.

An encoder block 402 consists of two layers. The first layer includes a multi-head self-attention component 410 followed by layer normalization component 412. The second layer includes a feed-forward neural network 414 followed by a layer normalization component 416. The context tensor 409 is input into the multi-head self-attention layer 410 of the encoder block 302 with a residual connection to layer normalization 412. The output of the layer normalization 412 is input to the feed-forward neural network 414 with another residual connection to layer normalization 416. The output of the encoder block 402 is a set of hidden representations 417. The set of hidden representations 417 is then sent through additional encoder blocks, if multiple encoder blocks exist, or to the decoder 304.

Attention is used to decide which parts of the input sequence are important for each subtoken, especially when decoding long sequences since the encoder is limited to encoding a fixed-size vector. Attention mechanisms gather information about the relevant context of a given subtoken and then encode that context into a vector which represents the subtoken. It is used to identity the relationships between subtokens in the long sequence while ignoring other subtokens that do not have much bearing on a given prediction.

The multi-head self-attention component 410 takes a context tensor 409 and weighs the relevance of each subtoken represented in the context tensor to each other by generating attention weights for each subtoken in the input embedding 406. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dᵥ. Q is a matrix that contains the query or vector representation of one subtoken in a sequence, K is the vector representations of all subtokens in the sequence, and V is the vector representations of all the subtokens in the sequence.

The queries, keys and values are linearly projected h times in parallel with dᵥ output values which are concatenated to a final value:
MultiHead (Q, K, V)=Concat(head₁, . . . , headₕ) W^{o},
where headᵢ=Attention(QWᵢ^{Q}, KWᵢ^{K}, VWᵢ^{V}),
with parameter matrices Wᵢ^{Q} ϵ [symbol] ^{d}^{_{model}}^{xd}^{ₖ}, Wᵢ^{K} ϵ [symbol] ^{d}^{_{model}}^{xd}^{ₖ}, Wᵢ^{V} ϵ [symbol] ^{d}^{_{model}}^{xd}^{ₖ}, and Wᵢ^{O} ϵ [symbol] ^{d}^{_{model}}^{xd}^{ₖ}.

In order to reduce the training time of the neural transformer, layer normalization is used between the layers. The layer normalization component normalizes the inputs across the features. The mean and standard deviation is computed across the feature dimensions. There is a first layer normalization 412 that precedes the feed-forward neural network 414 and a second layer normalization 416 that follows the feed-forward neural network 414.

The feed-forward neural network 414 processes each output encoding separately. The output of the top encoder block is a set of attention vectors K and V 417 which is used by the encoder-decoder multi-head attention layer 426 of each decoder block 404.

The decoder block 404 predicts each subtoken ti in the target language one-by-one at each time step conditioned on all previously-generated target subtokens t₁, . . . tᵢ₋₁. The decoder block 404 consists of three layers. The first layer includes a masked multi-head self-attention component 422 followed by a layer normalization component 424. The output of the layer normalization component 424 is input into the encoder-decoder multi-head attention component 426 with a residual connection to layer normalization component 428. The second layer includes an encoder-decoder multi-head attention component 426 followed by a layer normalization component 428. The output of layer normalization component 428 is input into the feed-forward neural network 430 with a residual connection to layer normalization component 432. The third layer includes a feed-forward neural network 330 followed by a layer normalization component 432.

The masked multi-head self-attention component 422 receives the output embeddings of the previous timestep. The masked multi-head self-attention component 422 masks the output embeddings from future time steps. The encoder-decoder multi-head attention layer 426 receives queries from the previous decoder layer 425 and the memory keys and values 417 from the output of the encoder block 402. In this manner, the decoder block 404 can attend to every position of the input sequence. The feed-forward neural network 430 processes each output encoding separately. A layer normalization component 424, 428, 432 is used between the layers in order to normalizes the inputs across the features.

The linear layer 434 projects the vector produced by the stack of decoders into a logits vector. The softmax layer 436 then turns the scores of the logits vector into probabilities for each subtoken in the vocabulary which are positive and normalized.

In one aspect, the neural transformer model contains a stack of n encoder blocks and a stack of n decoder blocks which are aggregated into a neural transformer block. The output of each encoder block is passed onto the next encoder block and processed. Each decoder block receives the attention weights computed from the last encoder block. The use of multiple stacked encoder blocks and decoder blocks increases the model's capacity allowing the model to learn increasing levels of abstraction.

### Methods

Attention now turns to a more detailed description of the methods used in the voice user interface. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

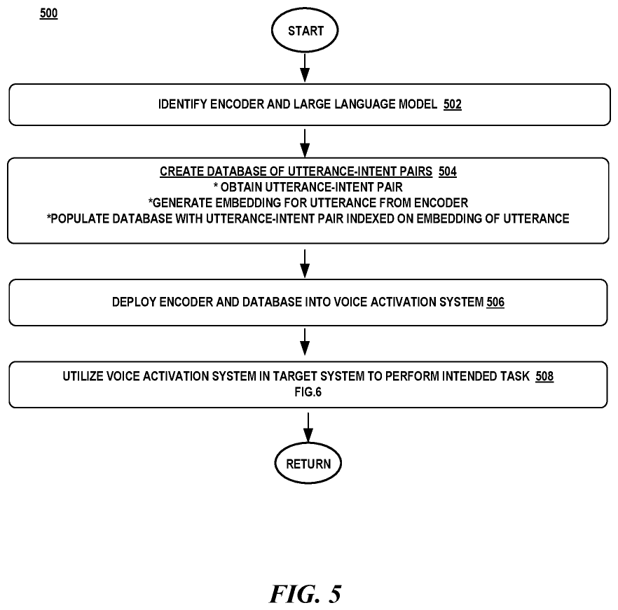

FIG. 5 is an exemplary method of the voice user interface 500. Referring to FIGS. 1 and 5, a large language model 112 is identified for predicting the intents (block 500). In an aspect, a publicly-accessible large language model is identified, such as a previously pre-trained large language model on natural language text and source code. The publicly-accessible large language model resides on an external server and the intent detection engine 108 communicates with the large language model 112 through Application Programming Interfaces (APIs) over a network.

An encoder 114 is also obtained (block 502). The encoder 114 generates an embedding for the developer utterance and for each utterance in the utterance-intent database. The encoder 114 may also be configured as an encoder neural transformer model with attention. An encoder neural transformer model with attention consists of several stacked encoder blocks pre-trained on utterances and/or natural language text. The Bidirectional Encoder Representations from Transformers (BERT) model is an exemplary encoder neural transformer model with attention.

The utterance-intent database 116 is created prior to the operation of the voice user interface 102 (block 504). Utterance and intent pairs are retrieved from known data. The database generator 204 uses the encoder 114 to generate an embedding of each utterance which is used as an index into the utterance-intent database 116 for the corresponding intent. The database generator 204 populates each utterance and its corresponding intent in the utterance-intent database 116.

The encoder 114 and the utterance-intent database 116 are deployed into the voice user interface 102 (block 506) and the voice user interface 102 is utilized in the target system 104 (block 508).

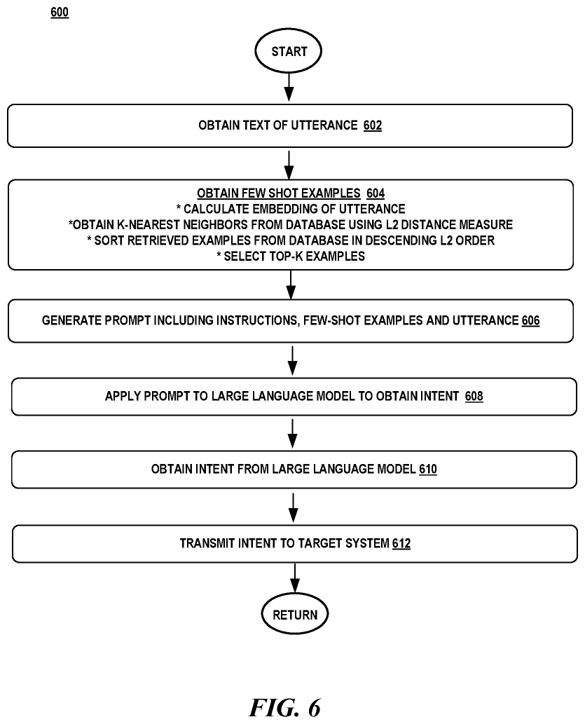

FIG. 6 illustrates an exemplary method 600 of the voice user interface. Referring to FIGS. 1 and 6, a developer speaks into an audio input device and the speech recognition engine captures the speech signals which are transformed into a text string of the utterance (block 602).

The intent detection engine 108 utilizes the prompt generator 110 to obtain the top-k few-shot examples 128 from the utterance-intent database 116 (block 604). An embedding of the utterance, Encode (U), is generated using the encoder 114, where U is the utterance. The prompt generator 110 computes the cosine similarity between the embedding of the utterance and the embedding of each utterance, Encode (uᵢ), in the utterance-intent database 116. The cosine similarity measure or L2 normalized Euclidean distance computes the distance between two embeddings as the difference of the squared vector values, which is represented as: L2(U, ui)=||Encode (U)−Encode (uᵢ)||₂², where U is the utterance, and uᵢ is the i-th utterance in the utterance-intent database 116. The top-k embeddings having the closest similarity measure are used as the few-shot examples 128.

The prompt generator 110 creates the prompt which includes instructions to the model for the target task, the few-shot examples, and the utterance (block 606). The prompt is input into the large language model (block 608) and the intent detection engine receives at least one intent back from the large language model (block 610). The intent detection engine transmits the intent to the IDE which implements the action of the intent (block 612).

### Technical Effect/Technical Improvement

Aspects of the subject matter disclosed herein pertain to the technical problem of identifying an intent for a given utterance. The technical features associated with addressing this problem includes augmenting a prompt to a large language model with a few-shot examples that guides the model to learn to make predictions from a few training samples with supervised information. The technical effect achieved is an increased accuracy of the predicted intent in a manner that is low-cost and computationally efficient over fine-tuning the model on the task of intent detection.

The identification of the intent has to be performed within tight timing requirements in order to be viable in a target system. For at least these reasons, the operations used to generate the prompt need to be performed on a computing device. The operations performed are inherently digital. A human mind cannot interface directly with a CPU, or network interface card, or other processor, or with RAM or digital storage, to read and write the necessary data and perform the necessary operations and processing steps taught herein.

Embodiments are also presumed to be capable of operating “at scale”, that is capable of handling larger volumes, in production environments or in testing labs for production environments as opposed to being mere thought experiments.

The technique described herein is a technical improvement over prior solutions that utilize rules to identify an intent using text matching. As the number and complexity of the intents grow, the rule-based approach becomes more complicated to extend, debug, and maintain.

The technique described herein is a technical improvement over prior solutions that utilized a machine learning model for intent detection having been trained on the intent detection task with a large training dataset of utterances labeled with their intents. Instead, the few-shot examples in the prompt are used to guide the model on the intent detection task without needing a large training dataset. In addition, the training of the machine learning model with the large training dataset consumes a vast amount of computing resources and time which is not always feasible. Furthermore, machine learning models are tied to the patterns seen in the training data and become stale when new utterance and intents become available. The few-shot examples in the prompt overcomes this problem.

### Exemplary Operating Environment

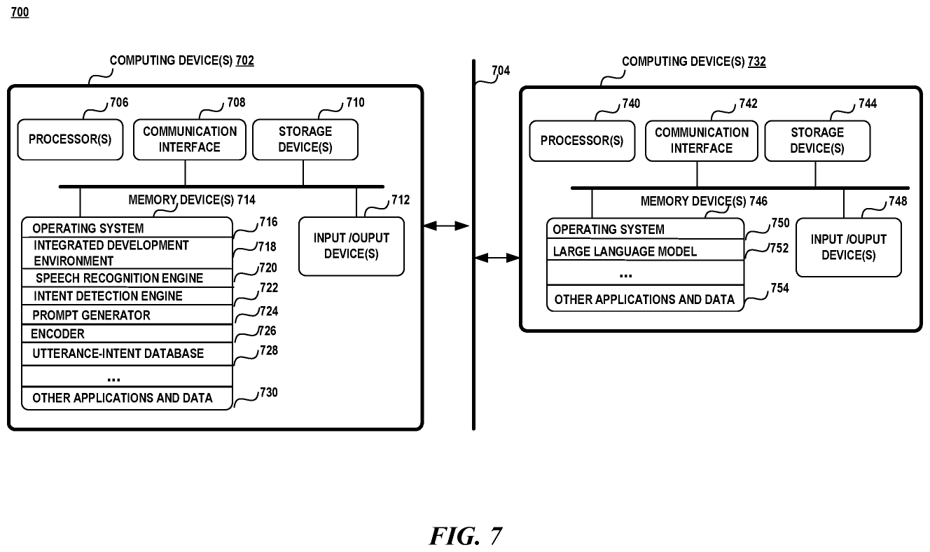

Attention now turns to a discussion of an exemplary operating environment 700. FIG. 7 illustrates an exemplary operating environment 700 in which one or more client computing devices 702 hosts the voice user interface and IDE and communicate with one or more computing devices 732 hosting the large language model. However, it should be noted that the aspects disclosed herein are not constrained to any particular configuration of the computing devices and that other configurations are possible. In other aspects, the voice user interface, IDE, and large language model may be hosted on the same computing device or hosted on the same cloud service.

A computing device 702, 732 may be any type of electronic device, such as, without limitation, smartphone, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 700 may be configured in a network environment, a distributed environment, a multi-processor environment, or a stand-alone computing device having access to remote or local storage devices.

A computing device 702, 732 may include one or more processors 706, 740, one or more communication interfaces 708, 742, one or more storage devices 710, 744, one or more memory devices or memories 714, 746, and one or more input/output devices 712, 748. A processor 706, 740 may be any commercially available or customized processor and may include dual microprocessors and multi-processor architectures. A communication interface 708, 742 facilitates wired or wireless communications between the computing devices and with other devices. A storage device 710, 744 may be computer-readable medium that does not contain propagating signals, such as modulated data signals transmitted through a carrier wave. Examples of a storage device 710, 744 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 710, 744 in a computing device 702, 732. The input/output devices 712, 748 may include a keyboard, mouse, pen, voice input device, touch input device, display, speakers, printers, etc., and any combination thereof.

A memory device or memory 714, 746 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 714 may also include one or more external storage devices or remotely located storage devices that do not pertain to propagated signals, such as modulated data signals transmitted through a carrier wave.

A memory device 714, 746 may contain instructions, components, and data. A component is a software program that performs a specific function and is otherwise known as a module, program, and/or application. Memory device 714 includes an operating system 716, an integrated development environment 718, a speech recognition engine 720, an intent detection engine 722, a prompt generator 724, an encoder 726, an utterance-intent database 728, and other applications and data 730. Memory device 746 includes an operating system 750, a large language model 752 and other applications and data 754.

The computing devices 702, 732 may be communicatively coupled via a network 704. The network 704 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 704 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Conclusion

A system is disclosed for intent detection comprising: one or more processors; and a memory that stores one or more programs that are configured to be executed by the one or more processors. The one or more programs including instructions to perform actions that: receive a developer-spoken utterance related to an action of an integrated development environment; obtain one or more few-shot examples associated with the developer-spoken utterance from a database; create a prompt for a large language model to identify an intent associated with the developer-spoken utterance, wherein the prompt includes the few-shot examples and the developer-spoken utterance, wherein the intent describes the one action to be performed in the integrated development environment; generate from the large language model, given the prompt, the intent; and process the intent in the integrated development environment.

In an aspect, the database includes a plurality of pairs of utterances and intents, wherein each pair of the plurality of pairs includes an utterance and an intent, wherein each pair of the plurality of pairs is indexed by an embedding of the utterance.

In an aspect, the one or more programs include further instructions to perform actions that: generate an embedding of the developer-spoken utterance; and search the database for embeddings of an utterance having a close similarity to the embedding of the developer-spoken utterance.

In an aspect, the one or more programs include further instructions to perform actions that: compute a cosine similarity of the embedding of the utterance of each pair with the embedding of the developer-spoken utterance; and select the top-k pairs having the closest cosine similarity as the few-shot examples for the prompt.

In an aspect, the prompt includes a first set of instructions that describes the few-shot examples. In an aspect, the prompt includes a second set of instructions that describes an intent detection task for the large language model and an expected response. In an aspect, the large language model is a neural transformer model with attention pre-trained on source code and/or natural language text. In an aspect, the large language model is pre-trained on natural language text and source code.

A computer-implemented method for intent detection is disclosed, comprising: obtaining a developer-spoken utterance of a developer while engaged with an integrated development environment; searching for at least one few-shot example associated with the developer-spoken utterance from a database of utterance-intent pairs; creating a prompt to identify an intent associated with the developer-spoken utterance, wherein the prompt includes the at least one few-shot example and the developer-spoken utterance, wherein the intent describes at least one action to be performed in the integrated development environment; transmitting the prompt to the large language model; obtaining from the large language model, in response to the prompt, the intent; and transmitting the intent to the integrated development environment.

In an aspect, the database of utterance-intent pairs is indexed by an embedding of an utterance. In an aspect, the computer-implemented method further comprises: generating an embedding of the developer-spoken utterance; and searching the database of utterance-intent pairs for embeddings of a pair having a close similarity to the embedding of the developer-spoken utterance.

In an aspect, the computer-implemented method further comprises: computing a cosine similarity of the embedding of the utterance of each pair with the embedding of the developer-spoken utterance; and selecting a closet pair having closest cosine similarity to the few-shot examples for the prompt.

In an aspect, the prompt includes a first set of instructions that describes the few-shot examples. In an aspect, the prompt includes a second set of instructions that describes an intent detection task for the large language model and an expected response. In an aspect, the large language model is a neural transformer model with attention pre-trained on source code and natural language text.

One or more hardware storage devices is disclosed having stored thereon computer-executable instructions that are structured to be executable by one or more processors of a computing device to thereby cause the computing device to perform actions that: obtain through a voice user interface a developer-spoken utterance to perform an action in the integrated development environment; create a prompt for a large language model to predict an intent of the developer-spoken utterance, wherein the prompt includes few-shot examples and the developer-spoken utterance, wherein the few-shot examples are supervised data that train the large language model on an intent detection task; apply the prompt to the large language model; obtain an intent corresponding to the developer-spoken utterance from the large language model; and apply the intent in the integrated development environment.

In an aspect, the one or more hardware storage devices of claim have further computer-executable instructions that are structured to be executable by one or more processors of a computing device to thereby cause the computing device to perform actions that: search a database of utterance-intent pairs for one or more utterance-intent pairs for the few-shot examples based on a closest similar embedding of the developer-spoken utterance to an embedding associated with each utterance-intent pair of the database.

In an aspect, the prompt includes a first set of instructions that describes the few-shot examples. In an aspect, the prompt includes a second set of instructions that describes the intent detection task for the large language model and an expected response. In an aspect, the large language model is a neural transformer model with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A system for intent detection comprising:
one or more processors; and
a memory that stores one or more programs that are configured to be executed by the one or more processors, the one or more programs including instructions to perform actions that:
receive a developer-spoken utterance related to an action of an integrated development environment;
obtain one or more few-shot examples associated with the developer-spoken utterance from a database;
create a prompt for a large language model to identify an intent associated with the developer-spoken utterance, wherein the prompt includes the few-shot examples and the developer-spoken utterance, wherein the intent describes the one action to be performed in the integrated development environment;
generate from the large language model, given the prompt, the intent; and
process the intent in the integrated development environment.

2. The system of claim 1, wherein the database includes a plurality of pairs of utterances and intents, wherein each pair of the plurality of pairs includes an utterance and an intent, wherein each pair of the plurality of pairs is indexed by an embedding of the utterance.

3. The system of claim 2, wherein the one or more programs include further instructions to perform actions that:
generate an embedding of the developer-spoken utterance; and
search the database for embeddings of an utterance having a close similarity to the embedding of the developer-spoken utterance.

4. The system of claim 3, wherein the one or more programs include further instructions to perform actions that:
compute a cosine similarity of the embedding of the utterance of each pair with the embedding of the developer-spoken utterance; and
select the top-k pairs having the closest cosine similarity as the few-shot examples for the prompt.

5. The system of claim 1, wherein the prompt includes a first set of instructions that describes the few-shot examples.

6. The system of claim 1, wherein the prompt includes a second set of instructions that describes an intent detection task for the large language model and an expected response.

7. The system of claim 1, wherein the large language model is a neural transformer model with attention pre-trained on source code and/or natural language text.

8. The system of claim 1, wherein the large language model is pre-trained on natural language text and source code.

9. A computer-implemented method for intent detection, comprising:
obtaining a developer-spoken utterance of a developer while engaged with an integrated development environment;
searching for at least one few-shot example associated with the developer-spoken utterance from a database of utterance-intent pairs;
creating a prompt to identify an intent associated with the developer-spoken utterance, wherein the prompt includes the at least one few-shot example and the developer-spoken utterance, wherein the intent describes at least one action to be performed in the integrated development environment;
transmitting the prompt to the large language model;
obtaining from the large language model, in response to the prompt, the intent; and
transmitting the intent to the integrated development environment.

10. The computer-implemented method of claim 9, wherein the database of utterance-intent pairs is indexed by an embedding of an utterance.

11. The computer-implemented method of claim 9, further comprising:
generating an embedding of the developer-spoken utterance; and
searching the database of utterance-intent pairs for embeddings of a pair having a close similarity to the embedding of the developer-spoken utterance.

12. The computer-implemented method of claim 9, further comprising:
computing a cosine similarity of the embedding of the utterance of each pair with the embedding of the developer-spoken utterance; and
selecting a closet pair having closest cosine similarity to the few-shot examples for the prompt.

13. The computer-implemented method of claim 9, wherein the prompt includes a first set of instructions that describes the few-shot examples.

14. The computer-implemented method of claim 9, wherein the prompt includes a second set of instructions that describes an intent detection task for the large language model and an expected response.

15. The computer-implemented method of claim 9, wherein the large language model is a neural transformer model with attention pre-trained on source code and natural language text.

16. One or more hardware storage devices having stored thereon computer-executable instructions that are structured to be executable by one or more processors of a computing device to thereby cause the computing device to perform actions that:
obtain through a voice user interface a developer-spoken utterance to perform an action in the integrated development environment;
create a prompt for a large language model to predict an intent of the developer-spoken utterance, wherein the prompt includes few-shot examples and the developer-spoken utterance, wherein the few-shot examples are supervised data that train the large language model on an intent detection task;
apply the prompt to the large language model;
obtain an intent corresponding to the developer-spoken utterance from the large language model; and
apply the intent in the integrated development environment.

17. The one or more hardware storage devices of claim 16 having stored thereon further computer-executable instructions that are structured to be executable by one or more processors of a computing device to thereby cause the computing device to perform actions that:
search a database of utterance-intent pairs for one or more utterance-intent pairs for the few-shot examples based on a closest similar embedding of the developer-spoken utterance to an embedding associated with each utterance-intent pair of the database.

18. The one or more hardware storage devices of claim 16, wherein the prompt includes a first set of instructions that describes the few-shot examples.

19. The one or more hardware storage devices of claim 16, wherein the prompt includes a second set of instructions that describes the intent detection task for the large language model and an expected response.

20. The one or more hardware storage devices of claim 16, wherein the large language model is a neural transformer model with attention.
